(19) United States
(12) Patent Application Publication
(10) Pub. No.: US 2024/0253599 A1
(43) Pub. Date: Aug. 1, 2024

(54) DEVICE FOR WIPING A MOTOR VEHICLE WINDOW

(71) Applicant: VALEO SYSTEMES D'ESSUYAGE, La Verriere (FR)

(72) Inventors: Quentin FAURIOL, La Verriere (FR); Benjamin BANNES, La Verriere (FR); Nicolas KUCHLY, La Verriere (FR); Pascal RENOUX, La Verriere (FR); Ga¿tan BESSON, La Verriere (FR)

(73) Assignee: VALEO SYSTEMES D'ESSUYAGE, La Verriere (FR)

(21) Appl. No.: 18/292,380

(22) PCT Filed: Jul. 27, 2022
(86) PCT No.: PCT/EP2022/071134

§ 371 Date: Jan. 26, 2024

(30) Foreign Application Priority Data
Jul. 30, 2021 (FR) FR2108342
Jul. 30, 2021 (FR) FR2108343

(51) Int. Cl. B60S 1/34; B60S 1/08; B60S 1/48

(52) U.S. Cl. CPC B60S 1/3415; B60S 1/08; B60S 1/3438; B60S 1/3443; B60S 1/3481; B60S 1/48

(57) ABSTRACT

The invention proposes a wiper device for wiping a window of a motor vehicle, comprising a head of a wiper arm, a housing of a drive motor for driving the head of the wiper arm, a circulation channel for circulating cleaning liquid to the wiper, extending through the drive motor housing and the head of the wiper arm. The device enables a simpler definition of the liquid circulation channel.

### TECHNICAL FIELD

The invention relates to a wiper device for wiping a window of a motor vehicle.

### BACKGROUND OF THE INVENTION

Document FR2735735 describes a wiper device for wiping a window of a motor vehicle, comprising a wiper extending longitudinally in a direction substantially parallel to the plane of the window. The wiper is fastened by an arm which is itself connected to a drive head on a drive shaft. The drive shaft comprises an inner duct for supplying washing liquid to a spray device fastened to the wiper. The drive head comprises an inner channel connected to the inner duct situated in the drive shaft.

The drawback of this wiper device is that it requires the definition of a cleaning liquid circulation channel inside the drive shaft and the supply of liquid via the shaft; such a definition is therefore complex.

There is a need to define a liquid circulation channel which is simpler.

### SUMMARY OF THE INVENTION

The aim of the invention is to provide a wiper device for wiping a window of a motor vehicle, wherein the cleaning liquid circulation channel is of a simpler definition.

To do so, the invention proposes a wiper device for wiping a window of a motor vehicle, comprising a head of a wiper arm, a housing of a drive motor for driving the head of the wiper arm, a circulation channel for circulating cleaning liquid to the wiper, extending through the drive motor housing and the head of the wiper arm.

According to one variant, the head of the arm is able to rotate with respect to the housing around a drive shaft for driving the head.

According to one variant, the head is situated outside the vehicle and the housing situated in a dry zone of the vehicle extends to the outside of the vehicle, the head and the housing being pushed one inside the other through the boundary between the dry zone and the outside of the vehicle, preferably the head is pushed into the housing.

According to one variant, the liquid circulation channel extends through a circumferential cavity delimited by the head and the housing when pushed together, the cavity being sealed by inner and outer circumferential seals between the head and the housing.

According to one variant, a seal between the head and the housing is in a groove of the head or of the housing and is pressed against the other of the head or the housing.

According to one variant, the seal situated in the groove is toric with a cross section in the shape of an X, D or O.

According to one variant, the device further comprises a recess in the head or the housing, the recess being open in the direction of the drive shaft and in the direction of the circumferential cavity, and a seal in the recess that is pressed against the other of the head or the housing.

According to one variant, the seal in the recess comprises branches that are articulated to one another and pressed against the head and the housing by the pressure of the cleaning liquid in the circumferential cavity, and a metal core in the branches.

According to one variant, the cleaning fluid circulation channel opens out toward a wiper blade from the head, the device further comprising a conveying tube for conveying the liquid between a connector on the head and a connector on the wiper blade, the connectors face one another and the tube being at least partially concealed by the wiper arm.

According to one variant, the housing of the motor extends from a dry zone of the vehicle to the outside of the vehicle through a seal through a window or a bodywork element.

According to another variant, the head of the arm comprises a part driven around a drive shaft by the motor and a part articulated to the wiper arm, the two parts being assembled together.

According to one variant, the two parts are assembled together by elastic fitting.

According to one variant, the elastic fitting of the two parts is in a direction parallel to the drive shaft or in a direction transverse to the drive shaft.

According to one variant, the parts comprise clips forming a spring engaging elastically and removably with the other part.

According to a non-claimed variant, provision is made of a wiper device for wiping a window of a motor vehicle, comprising a wiper arm, a head of the wiper arm, and a housing of a drive motor for driving the head of the wiper arm, the head of the arm comprising a part driven around a drive shaft by the motor and a part articulated to the wiper arm, the two parts being assembled together.

The device according to this non-claimed variant may further comprise one or more of the following aspects:
The two parts are assembled together by elastic fitting.
The elastic fitting of the two parts is in a direction parallel to the drive shaft or in a direction transverse to the drive shaft.
One of the parts comprises clips forming a spring engaging elastically and removably with the other part.
The device further comprises a circulation channel for circulating cleaning liquid to the wiper, extending through the motor housing and that part of the head of the arm which is driven by the motor.
The cleaning fluid circulation channel opens out toward a wiper blade from the head, the device further comprising a conveying tube for conveying the liquid between a connector on the head and a connector on the wiper blade, the connectors face one another and the tube is at least partially concealed by the wiper arm.
The head is situated outside the vehicle and the housing situated in a dry zone of the vehicle extends to the outside of the vehicle, the head and the housing being pushed one inside the other through the boundary between the dry zone and the outside of the vehicle, the head preferably being pushed into the housing.
The liquid circulation channel extends through a circumferential cavity delimited by the head and the housing when pushed together, the cavity being sealed by inner and outer circumferential seals between the head and the housing.
one of seals between the head and the housing is in a groove of the head or of the housing and is pressed against the other of the head or the housing; and the other of the seals between the head and the housing is in a recess in the head or the housing, the recess being open in the direction of the drive shaft and in the direction of the circumferential cavity, the seal being pressed against the other of the head or the housing.
The housing of the motor extends from a dry zone of the vehicle to the outside of the vehicle through a seal through a window or a bodywork element.

The different embodiments can be taken in combination or considered in isolation.

### BRIEF DESCRIPTION OF DRAWINGS

Further features and advantages of the present invention will become apparent from reading the following detailed description, for the understanding of which reference will be made to the appended figures:

FIG. 1 shows one example of embodiment of the wiper device for wiping a window of a motor vehicle;

FIG. 2 shows a detail of FIG. 1;

FIG. 3 shows the seals between the head and the housing in detail;

FIG. 4 shows one example of embodiment of the wiper device for wiping the window;

FIG. 5 shows one example of embodiment of the head of the wiper arm;

FIG. 6 shows another example of embodiment of the head of the wiper arm;

FIG. 7 shows one example of the fitting of the parts of the head;

FIG. 8 shows another example of the fitting of the parts of the head;

FIG. 9 shows the assembly of the parts of the head according to one example of embodiment; and

FIG. 10 shows the assembly of the parts of the head according to another example of embodiment.

The drawings in the figures are not to scale. Similar elements are generally denoted by similar references in the figures. In the context of this document, identical or analogous elements may bear the same references. Furthermore, the presence of reference numbers or letters in the drawings cannot be considered limiting, including when these numbers or letters are indicated in the claims.

### DETAILED DESCRIPTION OF THE INVENTION

The invention proposes a wiper device for wiping a window of a motor vehicle, comprising a head of a wiper arm and a housing of a drive motor for driving the head of the wiper arm. The device also comprises a circulation channel for circulating cleaning liquid to the wiper, extending through the drive motor housing and the head of the wiper arm. The device enables a simpler definition of the liquid circulation channel. Furthermore, the device enables a simpler definition of the channel, without risk of corrosion of the metal parts of the motor.

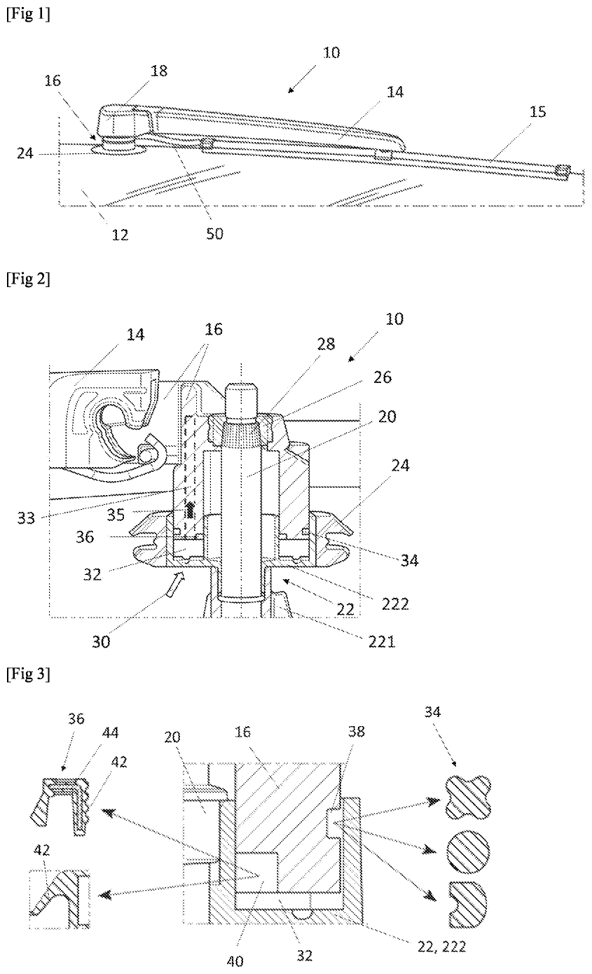

FIG. 1 shows a wiper device 10 for wiping a window 12 of a motor vehicle. The device 10 comprises an arm 14 driving, at one of its ends, a wiper blade 15 for wiping the window 12. It is a wiper device 10 for wiping a front or rear window of the vehicle. The device 10 comprises a head 16 of the wiper arm at the other end of the arm 14. The head 16 of the arm allows the arm to be driven by the head 16. In FIG. 1, the head of the arm is disposed under a cover 18.

FIG. 2 shows a detail of FIG. 1, in particular the head 16 in detail. The head 16 is connected to the arm 14, extending toward the left in FIG. 1. The head 16 is driven in rotation by a drive shaft 20. The shaft 20 protrudes from a housing 22 of a drive motor for driving the shaft 20.

The motor is in a dry zone of the vehicle. In other words, the motor is situated inside the vehicle, protected from the external weather conditions. The head 16 is outside the vehicle, not protected from the external weather conditions—if it is not covered by the cover 18 visible in FIG. 1. The boundary 12 between the dry zone and the outside of the vehicle is, for example, a bodywork element or the window 12 in FIG. 1. The device 10 comprises a seal 24 at the boundary between the dry zone and the outside of the vehicle. The seal 24 comprises a slot around its circumference in which the boundary—such as the bodywork or the window 12—is accommodated. The seal 24 provides sealing in contact with the boundary.

The motor housing 22 is in the dry zone of the vehicle, under the seal 24, and extends to the outside of the vehicle. More specifically, the motor housing 22 is circumscribed by the seal 24, at the boundary between the dry zone and the outside of the vehicle. Thus, since the housing 22 opens out to the outside of the vehicle, the drive shaft 20 extends from the motor in the dry zone to the outside of the vehicle, in order to drive the head 16 in rotation outside the vehicle. The housing 22 may be in one piece; this is visible in FIGS. 5 and 6. The housing 22 extends from the dry zone of the vehicle to the outside of the vehicle—through the boundary and the seal 24, and even beyond them. The advantage is that there are less components making up the housing 22 and therefore a reduced manufacturing and assembly cost. The housing 22 may also comprise several parts; in FIG. 2, the housing 22 comprises a part 221 in the dry zone, under the seal 24, and a part 222 circumscribed by the seal 24 and allowing the drive shaft 20 to extend to the outside of the vehicle. The advantage is that the housing 22 exhibits greater modularity, in the sense that the motor and its housing 22 can be used in other use configurations. The sealing around the shaft 20 is not described in more detail here.

The shaft 20 allows the head 16 to be driven in rotation. To do this, the head 16 has a shaping 26 allowing engagement with a toothing 28 situated at an end of the shaft 20, at the outside of the vehicle. Thus, the head 16 is able to rotate with respect to the housing 22 around the drive shaft 20 for driving the head 16. The head 16 is able to rotate, whereas the housing 22 opening out to the outside of the vehicle is immobile.

The head 16 and the housing 22 are pushed one inside the other through the boundary between the dry zone and the outside of the vehicle. Preferably, the head 16 is pushed into the housing 22. This allows the head 16 to be guided in rotation when it is being driven by the shaft 20.

The device 10 comprises a circulation channel for circulating cleaning liquid for the window 12. The liquid reaches the blade 15, so as to ensure effective cleaning of the window 12. The cleaning liquid circulation channel extends through the motor housing 22 and the head 16 of the wiper arm. In other words, the housing and the head are designed to define the liquid circulation channel. This makes it possible to define a path for the liquid through the parts of the window wiper device in a simpler manner. The passage of the liquid channel through the housing 22 and the head 16, and not through the drive shaft 20, offers greater freedom in defining the course of the channel. Furthermore, such a simpler definition of the channel is without risk of corrosion of the metal parts of the motor. In particular, since the motor housing 22 and the head 16 are preferably made of plastics material, there is no risk of corrosion of these parts—which occurs if the channel passes through the drive shaft 20. Moreover, the passage of the circulation channel through the motor housing 22 and the head 16 facilitates the realization of the sealing at the boundary between the dry zone and the outside of the vehicle. Specifically, the definition of the seal 24 is not affected by the liquid circulation channel and the seal 24 can therefore have a simple shape, namely a groove at its outer periphery for receiving the boundary 12 and an inner wall for matching the shape of the housing 22 which is an immobile part.

The cleaning liquid circulation channel reaches the motor housing 22 by the arrow 30 in FIG. 2. A connector on the housing 22—and more specifically on the part 222—allows the liquid to be conveyed to the housing 22. It may be an ordinary connector or a quick connector. Then the liquid circulation channel extends through a circumferential cavity 32 delimited by the head 16 and the housing 22 when pushed together. The cavity 32 is limited in the direction of the drive shaft 20 by the head 16 (toward the outside of the vehicle) and by the housing 22 (toward the dry zone) and more specifically the part 222 of the housing 22. The cavity 32 is delimited in the direction transverse to the drive shaft 20 by the housing 22—and more specifically by the part 222; the housing 22 comprises a circumferential slot around the passage of the drive shaft 20, the head 16 being pushed into said slot. This not only allows sliding contact between the housing 22 and the head 16 in order to guide the head 16 in rotation, but also allows the liquid to circulate from the housing 22, which is an immobile part of the device, to the head 16, which is a mobile part.

The cavity 32 is sealed by inner and outer circumferential seals 34, 36 between the head 16 and the housing 22. This allows the cleaning liquid to travel into the cavity 32 and pass from the immobile housing 22 into the rotatable head 16 without any risk of leaking.

According to FIG. 2, the circulation channel passes into the head 16 by way of a duct 33. The duct 33 extends in the direction of the drive shaft 20 and opens out into the cavity 32—which does not impede the demolding of the head 16 where applicable. The circumferential cavity 32 between the head 16 and the housing 22 allows the liquid to flow to the duct 33 (along the arrow 35), regardless of the angular position of the head 16 with respect to the housing 22 (or the part 222) —thus greatly facilitating the design of the circulation channel.

FIG. 3 shows the seals between the head 16 and the housing 22 in detail. The device comprises a first circumferential seal 34 between the head 16 and the housing 22. In particular, the seal 34 is between the head 16 and the part 222 of the housing 22. The seal 34 is around the outer circumference of the push-fit between the head 16 and the housing 22. The seal 34 is situated in a groove 38 of the head 16 or of the housing 22 and is pressed against the other of the head 16 or the housing 22. Preferably, the groove 38 is in the head 16 and the seal 34 is pressed against the housing 22. This is advantageous in the sense that the thickness of the head 16 in this zone is greater than the thickness of the housing 22, making it possible to more easily define the seal 34 and the groove 38 to meet the pressure and sealing constraints. The outer seal 34 makes it possible to withstand a pressure of between 2.5 and 5 bar of the liquid in the cavity 32. Furthermore, the outer seal 34 prevents the penetration of impurities from outside the vehicle, such as salt, dirt and cleaning liquid for the vehicle. The presence of the seal 34 in the groove 38 allows the seal 34 to be easily held in place. This also makes it possible to implement a seal of simple shape: in section, the seal 34 may be toric with a section in the shape of an X, D or O. This is given by way of example, other seal shapes could be used.

As is visible in FIG. 3, the device comprises a second circumferential seal 36 between the head 16 and the housing 22. In particular, the seal 36 is between the head 16 and the part 222 of the housing 22. The seal 36 is around the inner circumference of the push-fit between the head 16 and the housing 22. The seal 36 is situated in a recess 40 in the head 16 or in the housing 22 and is pressed against the other of the head 16 or the housing 22. Preferably, the recess 40 is in the head 16 and the seal 36 is pressed against the housing 22. This is advantageous in the sense that the thickness of the head 16 in this zone is greater than the thickness of the housing 22, making it possible to more easily define the seal 36 and the recess 40 to meet the pressure and sealing constraints. The inner seal 36 makes it possible to withstand a pressure of between 2.5 and 5 bar of the liquid in the cavity 32. Furthermore, the inner seal 36 essentially prevents the penetration of air—the seal 36 being situated further inside the device 10 than the seal 34.

The recess 40 is preferably in the head 16 for reasons of ease of designing the head 16 to be thicker in this zone than the housing 22. The recess 40 may be open in the direction of the drive shaft 20 and in the direction of the circumferential cavity 32. The presence of a recess that is open in these two directions facilitates the operations for demolding the head 16. The seal 36 in the recess 40 may comprise branches 42 that are articulated to one another and pressed against the head 16 and against the housing 22 by the pressure of the liquid in the circumferential cavity 32. The seal 36 may comprise several branches that are articulated to one another so as to be pressed against the head 16 and the housing 22. According to one embodiment given by way of example in FIG. 3, the seal 36 may comprise two branches 42 that are articulated to one another, one being pressed against the head 16 and the other against the housing 22. According to the other embodiment also given by way of example in FIG. 3, the seal 36 may comprise three branches 42, the branches 42 of each end being articulated to the central branch 42. The branches are held apart—and therefore pressed against the head 16 and the housing 22—by the pressure of the fluid in the cavity 32. This improves the sealing of the cavity 32. Furthermore, as is visible in FIG. 3, the seal 36 may comprise a metal core 44 (applicable to the two examples of a seal 36 in FIG. 3). The metal core 44 stiffens the seal 36, improving the sealing of the cavity 32 over time. Furthermore, since the metal core 44 is embedded in the seal 36, corrosion of the core 44 is prevented. This form of seal 36 is given by way of example, other forms of seals being able to be used.

The material used for the seals 34 and 36 is, for example, an elastomer such as NBR or synthetic rubber such as EPDM, preferably with a lubrication additive to facilitate the sliding contact with the housing 22.

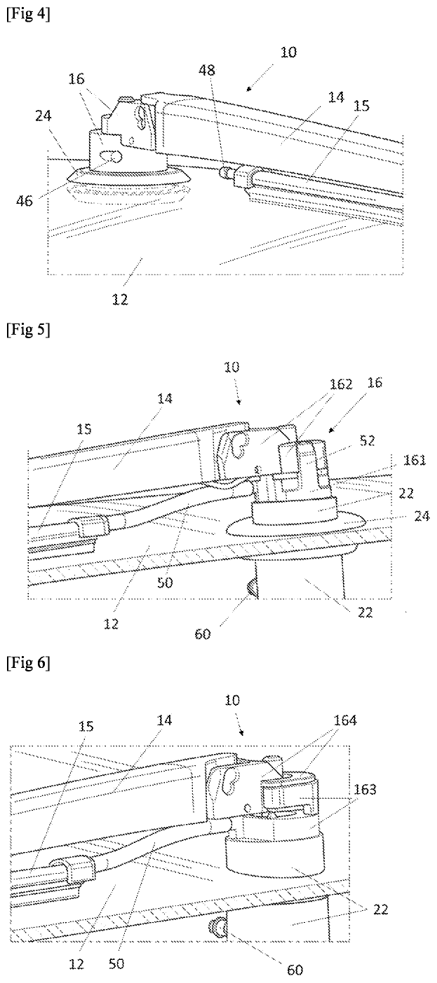

FIG. 4 shows one example of embodiment of the wiper device for wiping the window. According to this example, and from the arrow 30, the cavity 32 and the duct 33, the cleaning fluid circulation channel opens out toward the wiper blade 15 from the head 16—via the duct 33. The head 16 comprises a connector 46 in the continuation of the blade 15 which also comprises a connector 48. Between the connectors 46 and 48, the device comprises a tube 50 visible in FIG. 1. The connector 46 on the head 16 is in the continuation of the wiper blade 15—and the same applies to the connector 48. In other words, the connectors 46, 48 face one another and continue to do so during the movement of the device 10. This reduces the stresses in the blade 15 during its movement; specifically, since the head 16, the arm 14 and the blade 15 have a common rotational movement around the drive shaft 20, the positioning of the connector 46 in the continuation of the blade 15 prevents the movement of the blade 15 from being impeded. Furthermore, the conveying tube 50 for conveying the liquid between the two connectors 46, 48 is at least partially concealed by the wiper arm 14; this rendering the tube 50 less visible and protecting it. More specifically, since the connectors 46 and 48 are in the continuation of the blade 15, the tube 50 is held in position during the movement of the device 10, at least partially concealed by the arm.

Independently or in connection with the design of the cleaning liquid circulation channel, the head 16 may be in one piece or in several parts. According to FIGS. 2 and 4, the head 16 is in one piece; the head is a part which is, on the one hand, able to rotate with respect to the housing 22, and, on the other hand, articulated to the wiper arm 14. The circulation channel extends through the head 16 in the duct 33 to the connector 46. FIGS. 5 and 6 show other examples of embodiment of the head 16 of the wiper arm. In these examples, the head 16 is made of several parts. The head 16 comprises a part driven around the drive shaft 20 by the motor and a part articulated to the wiper arm 14, the two parts being assembled together. According to FIG. 5, the head 16 comprises a part 161 driven around the drive shaft 20 by the motor and a part 162 articulated to the wiper arm 14. According to FIG. 6 (in which the seal 24 is not shown), the head 16 comprises a part 163 driven around the drive shaft 20 by the motor and a part 164 articulated to the wiper arm 14. These other examples of embodiment of the head 16—independently of the definition of the cleaning liquid circulation channel in the device 10—enable a simpler definition of the head 16 of the wiper arm. Specifically, the definition of the head in several parts enables easier manufacture of each part by molding and a simpler definition of the method for demolding each part. Also, this definition of the head enables a simpler assembly of the head. Since one 161, 163 of the parts ensures the driving of the head 16 by the drive shaft and the other 162, 164 of the parts ensures the articulation of the head to the wiper arm 14, each of the parts has its own function and its own design. Thus, it is easier to design the structure of these two different parts—in order to then assemble them. Furthermore, such a design of the head reduces the volume of the head 16, and therefore of the device 10.

In connection with the definition of the cleaning liquid circulation channel in the device 10, the circulation channel for circulating cleaning liquid to the wiper extends through the motor housing 22 and that part 161, 163 of the head 16 of the arm which is driven by the motor. This makes it possible to limit the extension of the liquid circulation channel to that part of the head which is driven by the motor. This facilitates the definition of the other part 162, 164 articulated to the arm 14. The method for demolding this part 162, 164 is simplified due to the elimination of any liquid circulation channel in this part 162, 164.

According to one example of assembly, the parts 161, 162 and 163, 164 are assembled together by elastic fitting—or in other words, by clip-fastening. The advantage of such an assembly is that it is quick and simple.

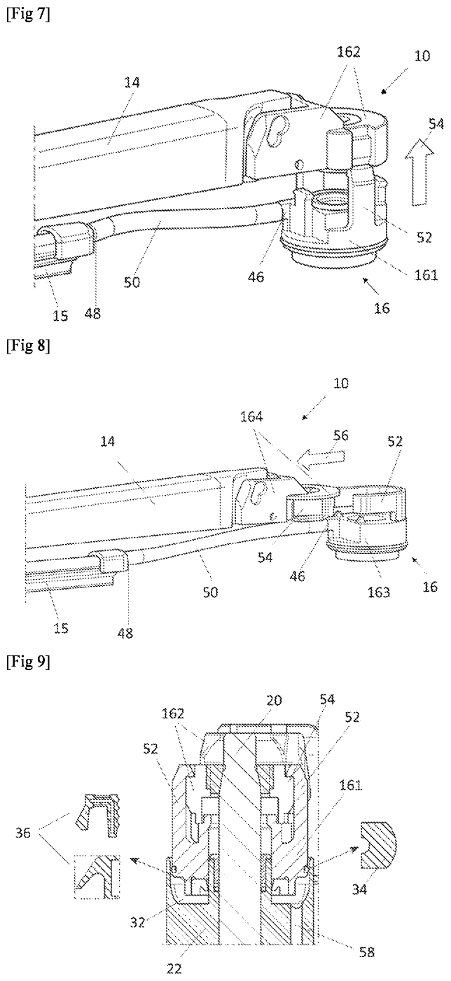

The elastic fitting of the two parts is in a direction parallel to the drive shaft or in a direction transverse to the drive shaft. This offers several mounting possibilities. According to FIG. 7, the fitting is in a direction parallel to the drive shaft, along the arrow 54. Such a direction of fitting is for example useful when the part 162 is already in an assembled position on the housing 22 and the shaft 20 (which are not visible in FIG. 7). For example, this is useful when it is necessary to change the arm 14 of the device 10 already in position on a vehicle because the removal of the part 162 is not impeded by the shaft 20. According to FIG. 8, the fitting is in a direction transverse to the drive shaft, along the arrow 56. Such a direction of fitting is for example useful when the part 164 is not yet in an assembled position on the housing 22 and the shaft 20 (which are not visible in FIG. 8). This is useful during the manufacture of the device 10.

The elastic fitting together of the parts may be effected by clips forming a spring on one of the parts and engaging elastically and removably with the other part. The clips deform elastically when fitting the parts together and then the clips regain their stable position in which the parts are held together. Since the clips are in a stable position, they are not stressed in the assembled position of the two parts together; this increasing the service life of the assembly. The clips form a spring in a removable manner in the sense that it is easy to remove the assembly of parts. This is useful for changing a part during the service life of the device. The clips can be opened with bare hands—making the removal easy—or with the aid of a tool—making the assembly more secure. One or more clips enable the assembly; it is preferable to have several clips, for example two, on either side of the drive shaft 20 in order to ensure good stability of the assembly.

According to FIGS. 5 and 7, the clips 52 are borne by the part 161 driven by the motor shaft. The clips 52 extend in the direction of the drive shaft (not visible). This facilitates the removal of the clips when necessary, because they are accessible from the top of the device 10. The fitting of the parts 161 and 162 in this direction causes the deformation of the clips 52 and then the return to the stable position to hold the parts 161 and 162 together. According to FIGS. 6 and 8, the clips 52 are borne by the part 163 driven by the motor shaft. This offers an alternative to the assembly in FIGS. 5 and 7. The clips 52 extend in the direction transverse to the drive shaft (not visible). The fitting of the parts 163 and 164 in this direction causes the deformation of the clips 52 and then the return to the stable position to hold the parts 163 and 164 together.

In connection with the liquid circulation channel, according to FIGS. 7 and 8, the parts 161 and 163 driven around a drive shaft by the motor support the duct 33 and the connector 46 for the connection of the tube 50 to the connector 48 of the blade 15. The connectors 46 and 48 face one another and continue to do so during the movement of the device 10.

FIG. 9 shows the assembly of the parts 161 and 162 according to FIGS. 5 and 7. The elastic fitting is in the direction of the drive shaft 20. The part 161 is driven around the drive shaft by the motor and the part 162 is articulated to the wiper arm. The fitting is effected by the clips 52, extending in the direction of the shaft 20; the clips 52 borne by the part 161 engage with a respective shoulder 54 of the part 162 articulated to the arm 14. The presence of two clips 52 ensures the stability of the assembly.

FIG. 9 also shows the circulation channel for circulating cleaning liquid through the housing 22. In the example in FIGS. 5 and 9, the housing 22 is in one piece and extends from the dry zone of the vehicle to the outside of the vehicle—through the boundary, and even beyond it. The circulation channel extends through the housing 22 via a duct 58 into the circumferential cavity 32. Again, the presence of the cavity 32 enables the supply from the housing 22 into the head 16 independently of the angular position of the head 16. The duct 33 is not shown in FIG. 9. FIG. 9 also shows the seals 34 and 36, the shape of which is by way of example, the other embodiments of the seals in FIG. 3 are conceivable.

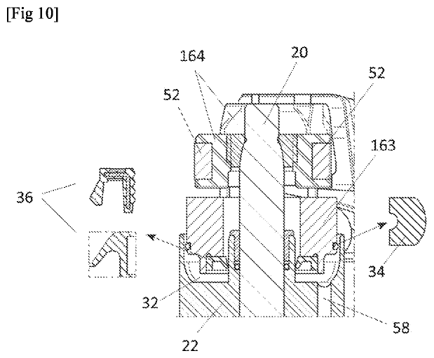

FIG. 10 shows the assembly of the parts 163 and 164 according to FIGS. 6 and 8. The elastic fitting is in a direction transverse to the drive shaft 20. The part 163 is driven around the drive shaft by the motor and the part 164 is articulated to the wiper arm. The fitting is effected by the clips 52, extending in the direction transverse to the shaft 20; the clips 52 borne by the part 163 engage with a respective shoulder 54 of the part 164 articulated to the arm 14 (not visible in FIG. 10 because it is a cross section—but visible in FIG. 8). The presence of two clips 52 ensures the stability of the assembly.

FIG. 10 also shows the circulation channel for circulating cleaning liquid through the housing 22. In the example in FIGS. 6 and 10, the housing 22 is in one piece and extends from the dry zone of the vehicle to the outside of the vehicle—through the boundary, and even beyond it. The circulation channel extends through the housing 22 via a duct 58 into the circumferential cavity 32. Again, the presence of the cavity 32 enables the supply from the housing 22 into the head 16 independently of the angular position of the head 16. The duct 33 is not shown in FIG. 10. FIG. 10 also shows the seals 34 and 36, the shape of which is by way of example, the other embodiments of the seals in FIG. 3 are conceivable.

FIGS. 5 and 6 show a connector 60 on the housing 22, in the dry zone of the vehicle. The connector 60 could also be connected to the housing part 222 at the arrow 30 in FIG. 2. Thus, the liquid circulation channel may extend from the connector 60, to the duct 58 or even the part 222, then to the cavity 32, the duct 33 in the one-piece head 16 or in the part 161 or 163 of the head 16 made of several parts, then to the blade 15 via the tube 50 between the connectors 46 and 48. Such a channel ensures a simpler definition of the elements of the device (and a reduction in the number of elements because it is not necessary to provide a separate tube over the entire route of the channel in the housing and the head), of their manufacturing process and of the sealing of the device itself but also through the boundary between the dry zone and the outside of the vehicle.

The present invention has been described in relation to specific embodiments, which have purely illustrative value and should not be considered limiting. In general, it will be obvious to a person skilled in the art that the present invention is not limited to the examples illustrated and/or described above. Notably, any type of seals 34, 36 could be used in the context of the invention, the seals shown in the figures being given by way of example.

What is claimed is:

1. A wiper device for wiping a window of a motor vehicle, comprising
a head of a wiper arm,
a housing of a drive motor for driving the head of the wiper arm, and
a circulation channel for circulating cleaning liquid to the wiper, extending through the drive motor housing and the head of the wiper arm.

2. The device as claimed in claim 1, wherein the head of the arm is able to rotate with respect to the housing around a drive shaft for driving the head.

3. The device as claimed in claim 1, wherein the head is situated outside the vehicle and the housing situated in a dry zone of the vehicle extends to the outside of the vehicle, the head and the housing being pushed one inside the other through the boundary between the dry zone and the outside of the vehicle, preferably the head is pushed into the housing.

4. The device as claimed in claim 3, wherein the liquid circulation channel extends through a circumferential cavity delimited by the head and the housing when pushed together, the cavity being sealed by inner and outer circumferential seals between the head and the housing.

5. The device as claimed in claim 4, wherein a seal between the head and the housing is in a groove of the head or of the housing and is pressed against the other of the head or the housing.

6. The device as claimed in claim 5, wherein the seal situated in the groove is toric with a cross section in the shape of an X, D or O.

7. The device as claimed in claim 4, further comprising
a recess in the head or the housing, the recess being open in the direction of the drive shaft and in the direction of the circumferential cavity,
a seal in the recess that is pressed against the other of the head or the housing.

8. The device as claimed in claim 7, wherein the seal in the recess comprises:
branches that are articulated to one another and pressed against the head and the housing by the pressure of the cleaning liquid in the circumferential cavity,
a metal core in the branches.

9. The device as claimed in claim 1, wherein the cleaning fluid circulation channel opens out toward a wiper blade from the head, the device further comprising a conveying tube for conveying the liquid between a connector on the head and a connector on the wiper blade, the connectors face one another and the tube being at least partially concealed by the wiper arm.

10. The device as claimed in claim 1, wherein the housing of the motor extends from a dry zone of the vehicle to the outside of the vehicle through a seal through a window or a bodywork element.

11. The device as claimed in claim 2, wherein the head of the arm comprises a part driven around a drive shaft by the motor and a part articulated to the wiper arm, the two parts being assembled together.

12. The device as claimed in claim 11, wherein the two parts are assembled together by elastic fitting.

13. The device as claimed in claim 12, wherein the elastic fitting of the two parts is in a direction parallel to the drive shaft or in a direction transverse to the drive shaft.

14. The device as claimed in claim 12, wherein the parts comprise clips forming a spring engaging elastically and removably with the other part.
